(19) United States
(12) Patent Application Publication
(10) Pub. No.: US 2010/0065635 A1
(43) Pub. Date: Mar. 18, 2010

(54) INDIVIDUAL IDENTIFICATION AND TRANSPORT SYSTEM FOR USE IN THE HANDLING OF DEAD FURRED ANIMALS AND PELTS FROM FURRED ANIMALS

(75) Inventor: Jens Hedegaard, Holstebro (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: DANSK MINK PAPIR A/S, Holstebro (DK)

(21) Appl. No.: 12/516,952

(22) PCT Filed: Nov. 26, 2007
(86) PCT No.: PCT/DK07/50176

§ 371 Date: May 29, 2009

(30) Foreign Application Priority Data
Nov. 29, 2006 (DK) PA 2006 01569

(51) Int. Cl. G06F 19/00

(52) U.S. Cl. 235/385; 235/375

(57) ABSTRACT

Individual identification and transport system for handling of dead furred animals and fur pelts, e.g., on mink farms, pelt processing plants, collection and sorting centers, auction houses, tanneries, and other processing of pelts from furred animals, has an electronically readable data media for individual identification data (ID-data) for an actual furred animal, and where the electronically readable data media is integrated in a transport and handling arrangement which is inserted through the nostrils of a relevant furred animal immediately after the furred animal has been killed. The transport and handling arrangement constitutes part of a transport and handling system for transport and handling of furred animals and pelts, and which remains together with the pelt from the time at which it is inserted into the pelt until it is processed into fur. The system enables the amount of manual work for the fur farmer and auction houses to be reduced.

### BACKGROUND OF THE INVENTION

1. Field of Invention

The present invention relates to an individual identification and transport system for use in the handling of dead furred animals and pelts from furred animals, namely mink and mink pelts on mink farms, pelt processing plants, collection and sorting centers, auction houses, tanneries, and other processing of pelts from furred animals.

2. Description of Related Art

Today, such systems are known only as marking systems where, for example, after the conclusion of the drying process, the mink pelts or similar pelts are removed from the pelt boards on which they are dried and are provided with a marker which states only the place of origin (the farm) and the pelt's size category and color, so that an account can be drawn up for the correct fur farmer after the pelts are sold by auction. The use of said marking systems thus involves a relatively great amount of manual work with regard to the sorting of the pelts, partly at collection centers and later at the auction houses, where the pelts are sorted in size categories and color, and thereafter auctioned off in bundles. Moreover, the marker is attached to the nose end of the pelt at a relatively late time, and does not contain any data other than that already mentioned above.

There is also a distinct need to be able to register production data for a relevant pelt, i.e., data concerning the origin of the actual animal (genealogical table), possible sicknesses during the rearing period, food consumption, growth per feed unit, and data concerning the relevant animal's pelt, such as size, quality, color etc. Today, this data is collected in a more or less sporadic manner, and by the fur farmers is sought to be made operational in connection with the breeding work. At the present time, there has been developed software for the recording of genealogical tables and feedstuff consumption, but at present, there does not exist any automatic coupling between this data and registration of the achieved size and quality of the pelt, which is still evaluated during subsequent manual sorting.

Moreover, a relatively great amount of manual work is involved in the handling of the dead animals in connection with the handling of the pelts from the time that the animals are skinned, to their internal transport in the processing plant and in the sorting, both at the local processing plant, collection centers and at auction houses, which out of regard for a minimization of the cost of production of pelts is desired to be reduced to a minimum. For example, the dead furred animals are tumbled in rotating drums, cooled and tumbled again for softening before they are skinned, often in a pelt robot, after which the pelt is fed further to a scraping machine/robot, and then, the pelt is turned and again tumbled before being mounted on a pelt board and dried (tanned), all of which are operations which require a great deal of manual work in connection with transport between the different places at which said operations are carried out.

### SUMMARY OF THE INVENTION

It is the object of the invention to provide a transport and marking system which offers a solution to some of the above-mentioned problems.

This object is achieved with an individual identification and transport system for use in the handling of dead furred animals and pelts from furred animals, namely mink and mink pelts on mink farms, pelt processing plants, collection and sorting centers and auction houses, which is characterized in that it comprises an electronic data scanning means for individual identification data (ID-data) for an individual furred animal, and where the electronically scanned data, integrated in a transport and handling arrangement, is inserted in the nose end of a relevant animal immediately after the killing of the animal, said handling arrangement comprising a part of a transport and handling system for transport and handling of furred animals and pelts, and is configured so that the transport and handling arrangement remains together with the pelts from the time of insertion until they are processed into furs.

By providing a dead furred animal with a data medium which can be scanned electronically by scanning units which, via an interface are coupled to at least one, preferably more, data processing units containing data concerning said animal's growth etc., the possibility is hereby achieved of being able to quickly couple the animal's genealogical data with data collected during the animal's period of growth containing information concerning feedstuff consumption, growth, sickness and other data such as behavior patterns etc.

Moreover, there is opened the possibility that further important information concerning a relevant animal's pelt size and quality can be registered automatically in connection with the tanning and drying of the pelt, and related to the above-mentioned data concerning the animal's ancestors and growth, so that the breeder can form a total impression of the efficiency of the production on the farm, right down to the individual animal level, and other interested parties, e.g., buyers of the pelts at the auction houses, can select precisely that type of pelt which is desired, and also have access to information concerning the animal's origins and conditions of growth etc.

The key to said data thus lies in the providing of each dead animal with a transport and handling arrangement containing identification data for the relevant animal/pelt, with the result that data concerning the animal/pelt collected in a database in a data processing unit can be related to the relevant dead animal/pelt.

Furthermore, by combining/integrating the electronically scanned data and the writeable data media in a transport and handling arrangement which consists of a part of a transport and handling arrangement for transport and handling of furred animal and pelts, and which remains together with the pelt from the time of insertion until this is processed into furs, there is achieved the possibility of rendering superfluous the manual labor in processing plants where, after the mounting of the transport and handling arrangement in the nose end of the furred animal/pelt, the dead animal can be handled during and transported mechanically between the different operations in the pelt processing plant.

The transport typically takes place where the pelts hanging from the nose end in the transport and handling bracket are typically fed in rail systems with feeding units and/or magazines, in which the transport brackets are inserted into special emptying/filling station. Of further considerable advantages, it is noted that the transport and handling arrangement containing ID-data, combined with transport systems and sorting plants with associated scanning units for electronically readable and writeable data media can render superfluous the sorting of pelts which at present takes place at the collection centers to which the pelt farmers deliver their pelts. Thus, the sorting of the pelts at the fur farmer and in the auction houses will be able to be automated so that the very extensive manual work involved in the sorting and handling of pelts arriving at the auction houses can be reduced to a minimum, so that the manual work consists only of a quality evaluation of the incoming pelts with regard to color, shades, gloss etc. and that the sorting of the incoming pelts into lots within each individual category can take place automatically after the manual quality evaluation, for example, with a simply-operated hand terminal which, via an interface connection with one or more central data processing units which control one or more sorting plants in the auction house, enables it to be ascertained where a relevant pelt happens to be at any given time. This also provides the possibility for a considerable simplification of settlement from the auction houses to the fur farmer, in that almost immediately there will be an overview of which pelts have been sold to which prices, and which breeders shall receive statements of account.

The electronically readable data media can, with advantage, also be writeable. The data media will thus be able to be provided with ID-data with the insertion of the handling and transport arrangement in the nose end of the dead furred animal or a pelt. However, the ability of the electronically readable data media to be written will be dependent on the entering of a previously provided authorization code.

In the following, the electronically readable media is randomly referred to as a readable and writeable data media, but this is for the sake of simplicity as said media can be only readable or only writeable or both,

With the object of being able to carry out an effective fastening of the transport and handling arrangement in the nose end of a furred animal/pelt, the transport and handling arrangement can comprise a cooperating base element in which the electronically readable and writeable data media is integrated, said base element comprising a protruding flexible band or a stalk having a free end comprising spaced projections or locking grooves, and where said free end can be inserted into and be lockable in openings in either at least one locking head on the stalk or the band, locking mechanisms in the basic element, or in openings in the end of the band or the stalk connected to the base element, so that after insertion into one of said openings the band or the stalk is self-locking.

It is hereby achieved that the transport and handling arrangement will be able to mounted in the nose end of a dead furred animal or a pelt in a relatively easy manner, where the fastening to the nose end is effected by insertion of the free end of the flexible band or stalk transversely through the nostril openings, after which the free end is inserted into openings either in the locking head on the stalk or the band, locking mechanisms in the base element, or in openings in the band or the stalk in the base element for locking, after which the transport and handling arrangement is connected with the dead furred animal/pelt until it is finally removed mechanically by the cutting-over of the band/the stalk when there is no longer use for the transport and handling arrangement.

With the object of ensuring a simple and cheap transport of the pelts, the base element can be designed to be accommodated in slotted rail profiles associated with the transport and handling system, and where the base element comprises at least one slide surface which cooperates with facing surfaces of the rail profile, so that the flexible band or stalk is extending through the slot in the rail profile.

There is hereby provided the possibility of a relatively inexpensive embodiment of the transport and handling arrangement, and at the same also of the rail system which is used in the transport and handling system. In principle, the rail system is arranged in the same way as a traditionally formed curtain rail with runners in a slotted track.

With the object of ensuring a quick mounting of the transport and handling arrangement in the nose end of a dead furred animal, the free end of the band/stalk can be pointed for insertion through the nostrils of the dead animal.

With the object of further optimization of the mounting of the transport and handling arrangement, the identification and transport system can also comprise a mounting arrangement for the insertion of the transport and handling system in the nose end of a dead furred animal by insertion of the free ends of the band/the stalk either in the locking head on the band or the stalk, locking mechanisms in the base element, or in openings in the end of the band/stalk connected with the base element, so that after insertion in one of said openings, the band/stalk is locked.

With the object of ensuring that all furred animals/pelts which are provided with a transport and handling arrangement are provided with ID-data, the mounting arrangement can comprise a read and write unit connected to a control unit which, via interface, stands in connection with at least one electronic register in a first data processing unit for control of and/or coding of authorized ID-data into the electronically readable and writeable data media, and where said mounting arrangement comprises an electronically activated lock which blocks for insertion of the transport and handling arrangements if integrated electronically readable and writeable data does not contain authorized ID-data.

It is hereby ensured that the furred animal or pelt provided with a transport and handling arrangement according to the invention cannot be inserted before authorized ID-data for the relevant animal/pelt is coded into the electronically readable and writeable data media which is integrated in the transport and handling arrangement. In other words, a pelt without authorized ID-data cannot be transported/handled by the transport system.

With the object of being able to add further data concerning pelt size obtained for a relevant pelt after tanning etc., the transport and handling system can comprise a plurality of electronic scanning units for the reading of ID-data on the electronically readable and writeable data media, where said reading units are connected via interface to at least one electronic register in at least a second data processing unit containing electronically registered and/or manually registered and reported production data collected at relevant places and times during the course of production for a relevant pelt.

It is hereby achieved that a relevant pelt provided with the transport and handling arrangement at the tanning machine can identify itself, and data for measured pelt size obtained after the tanning of the pelt can thus be transferred manually or automatically from the tanning machine to the electronic register containing other data concerning the origin of the relevant pelt. This means that already, immediately after the tanning of the pelt, it will be possible to transmit data to the auction houses concerning the pelts which, after drying and sorting, will be ready for delivery, which in turn gives the buyers the possibility of directing their attention to precisely the pelt size and quality in which they are interested in purchasing.

With the object of being able to make the sorting of the pelts provided with the transport and handling arrangement comprising the electronically readable and writeable data media with authorized ID-data more efficient, the second data processing unit, on the basis of the software it contains for the sorting of the pelts, via interface and control software, can be arranged in such a manner that it controls one or more sorting plants which are associated with the transport and handling system. It is hereby achieved that a pelt can be sorted out both locally at the breeder, providing that he has a sorting plant, as well as centrally at the auction houses. The sorting of pelts can thus be initiated already at the preliminary sorting which takes place at the fur farmer, so that this can accommodate relevant auction house sorting logistics, which can contribute towards a shortening of the time used for sorting at the auction house, since the sorting has already been initiated in relation to planned pelt lots/bundles.

With the object of keeping the pelts with the electronically readable and writeable data media in the nose end suspended in the transport and handling arrangement as long as possible, the second part of the individual identification and transport system according to the invention can comprise a slotted rail system for transport of furred animals and pelts, individually movable magazines comprising slotted support rails for accommodating a number of transport and handling arrangements, wheeled transport carriages comprising slotted support rails for a number of individually movable magazines, a number of emptying and filling stations respectively for transfer of transport and handling arrangements to magazines and for transfer of the magazines to and from the emptying and filling stations to and from wheeled transport carriages, and one or more sorting plants for sorting of the pelts in size categories and color by introduction of the transport and handling arrangements into relevant magazines via relevant emptying/filling stations.

There is hereby provided a complete individual identification and transport system for use in the handling and transport, both internally at the fur farmer as well internally at the auction houses, and for internal transport and sorting of the pelts arriving at the relevant auction house. The pelts can thus be sorted at the fur farmer and be placed in magazines, sorted according to color, quality and size, and as such transported on wheeled carriages/racks which can be placed in trucks, vans and the like to the appropriate auction houses, which in their internal sorting plant can continue sorting and the quality evaluation of the pelts.

With the object of ensuring that transport and handling arrangements which are placed in magazines with furred animals/pelts hanging from the nose end remain at a relevant magazine during transport/transfer, the magazines can comprise an end stop which can be deactivated.

With the object of being able to localize a given dead furred animal/pelt at decisive positions, the individual identification and transport system can comprise a number of scanning units placed at relevant positions which, via an interface are coupled respectively to first and second data processing units.

It is noted that the electronically readable and writeable data media can, with advantage, consist of an RFD chip or a corresponding data media.

For the driving of the transport and handling arrangements with pelts, the rail system can comprise driving arrangements for the feeding of the transport and handling units.

With the object of ensuring a quick transfer of data, and to enable a flexible positioning and use of the electronic reading/writing units for electronic scanning/coding of ID-data in the electronically readable and writeable data media, the interface between the reading/writing units and respectively the first and the second data processing and control unit, can consist of wireless communication equipment.

It is noted that the handling and transport system can, with advantage, consist of plastic, nylon of other traction-resistant materials.

In the following, the invention is explained in more detail with reference to the accompanying drawings

### BRIEF DESCRIPTION OF THE DRAWINGS

FIG. 1 is a perspective view of a transport and handling arrangement containing an electronically readable and writeable data media associated with the individual transport and handling system according to the invention,

FIG. 2 is a detail section of a magazine for the storage of transport and handling arrangements according to the invention, where a transport arrangement is seen immediately before insertion into the magazine's carriers/feeding rails.

FIG. 3 is a perspective view of a first embodiment of emptying/filling stations for emptying/filling of magazines associated with the individual transport and handling system according to the invention, with a transport and handling arrangement inserted.

FIG. 4 is a detail section of FIG. 3 showing a magazine for storage of transport and handling arrangements according to the invention, where a transport arrangement is seen inserted in the magazine's carriers/feeding rails by means of emptying/filling stations.

FIG. 5 is a perspective view of the embodiment of the emptying/filling station shown in FIG. 3 for the emptying/filling of magazines associated with the individual transport and handling system, comprising a magazine mover, according to the invention.

FIG. 6 is a perspective view of a first embodiment of a magazine for storage of transport and handling arrangements shown in FIG. 1.

FIG. 7 is a perspective view of a magazine emptier for emptying of magazines for transport and handling arrangements containing an electronically readable and writeable data media associated with the individual transport and handling system according to the invention, and

FIG. 8 is a perspective view of the magazine emptier shown in FIG. 7, where the wall of the cabinet is transparent, and

FIG. 9 is a perspective view of the magazine emptier shown in FIGS. 7 and 8, seen at an angle from below

### DETAILED DESCRIPTION OF THE INVENTION

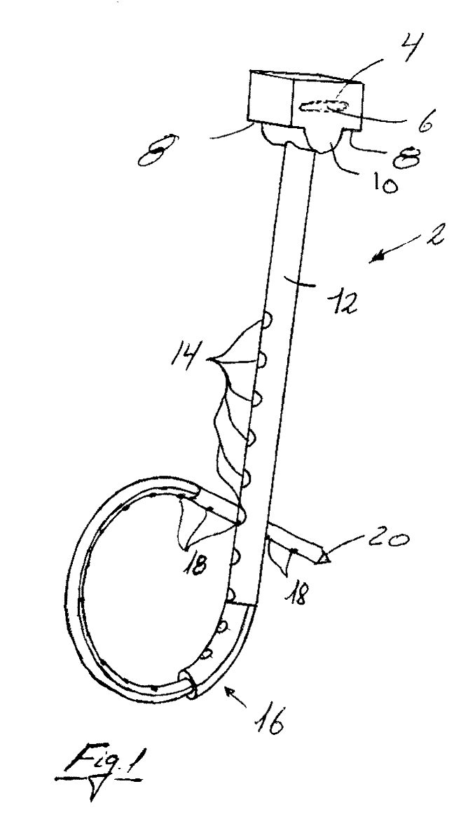

In FIG. 1, there is shown an individual identification and transport system according to the invention for use in the handling of dead furred animals and pelts from furred animals, namely mink and mink pelts on mink farms, pelt processing plants, collection and sorting centers, auction houses, tanneries, and other processing of pelts from furred animals.

As will appear in FIG. 1, the transport and handling arrangement 2 comprises a base element 4 in which there is integrated an electronically readable and writeable data media 6 which will typically be in the form of an RFID-chip. As will also appear, the base element 4 comprises slide surfaces 8 on each side of a curved projection 10, which comprises a projecting stalk 12 comprising a number of spaced through-going locking holes 14 for receiving the free flexible end 16 of the stalk, which comprises a number of spaced projections 18, and which by being pressed through a locking hole 14 is held in the locked position. As will also appear, the free flexible end 16 of the stalk has a point 20 which eases insertion of this transversely through the nostrils of a dead furred animal or pelt (not shown).

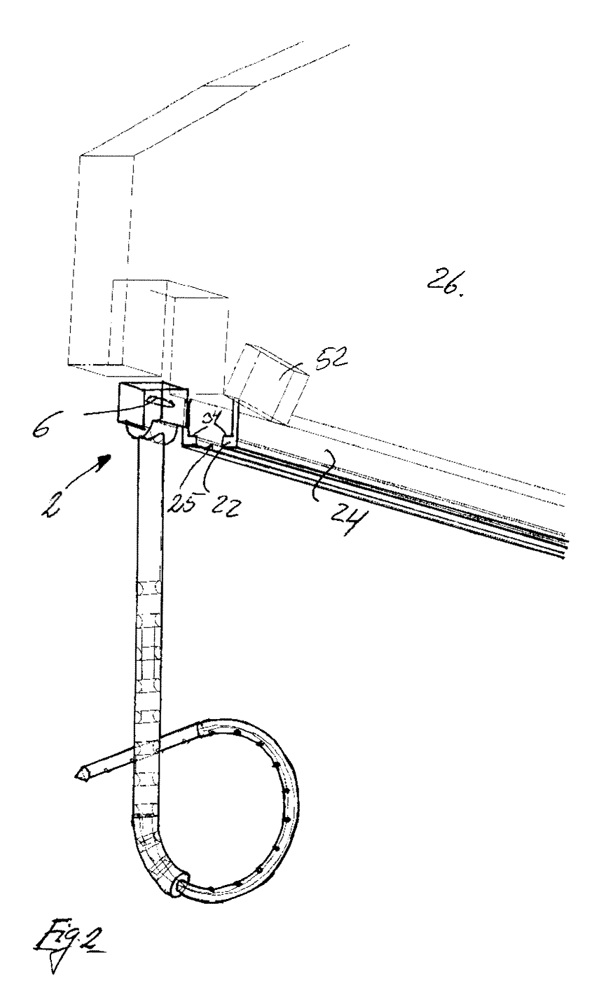

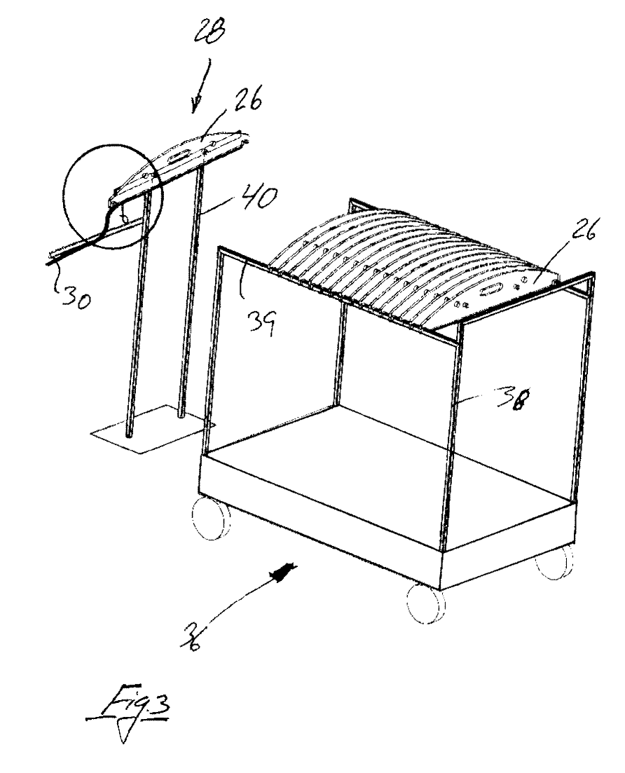

In FIG. 2, there is shown a transport and handling arrangement 2 placed opposite the end 22 of a feeding and carrier rail 24 with a slot 25, in a magazine 26 (see also FIG. 3, et al.) for storage and transport of a plurality of transport and handling arrangements 2, with the free end 16 of the stalk 12 led through the nostrils of a dead furred animal or a pelt (not shown) and locked in one of the locking holes 14.

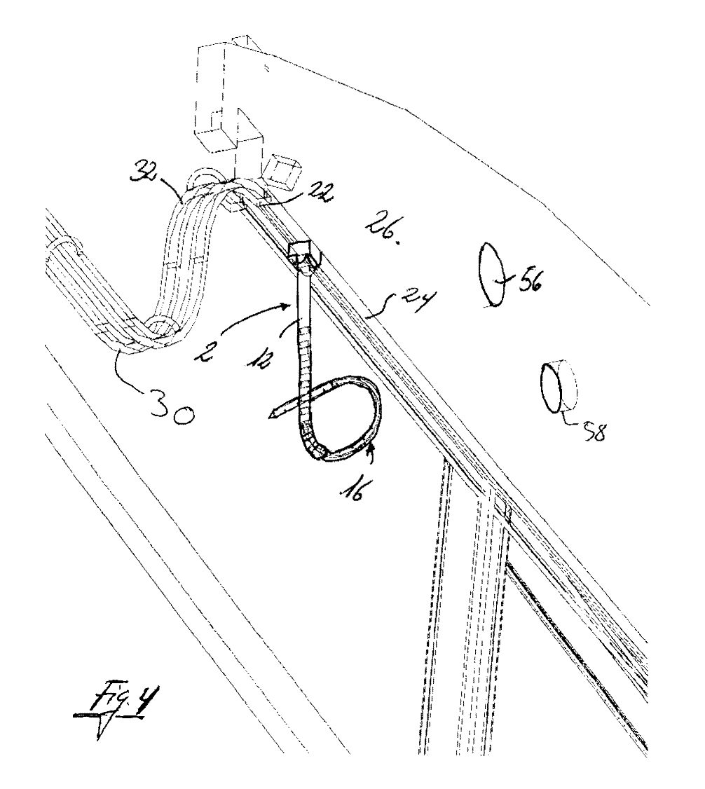

In FIG. 3, there is shown a first embodiment of an emptying/filling station 28 for the filling of magazines 26 associated with the individual transport and handling system according to the invention, with a transport and handling arrangement 28 inserted. As is seen in FIG. 3, and more clearly in FIG. 4, which is an enlargement of the encircled detail in FIG. 3, the emptying/filling station 28 comprises a guide rail 30 which leads the transport and handling arrangements 28 up from to the end 22 of the guide and carrier rail 24 in the magazine 26, where the support surfaces 22 of the guide rail 24 are placed opposite each other and in immediate extension of the support surfaces 32 of the guide rail 24. As will be seen in FIG. 4, a transport and handling arrangement 2 is fed in to the guide and support rail 24, with the stalk extending downwards and out through the slot 25. The feeding of the transport and handling arrangement 2 along the support surfaces 32, 34 is effected by drivers (not shown).

In FIG. 3, a wheeled transport carriage 36 comprising a rack 38 for the storage of a plurality of magazines 26 can also be seen. The carriage 36 can be used both for internal transport of dead furred animals or pelts between different processing procedures, as well as for external transport of dried pelts to the auction houses, and for internal transport in the auction houses.

FIG. 3 also shows a support bracket 40 on which a magazine 26 is secured during the loading of transport and handling arrangement 2 with dead furred animals or pelts.

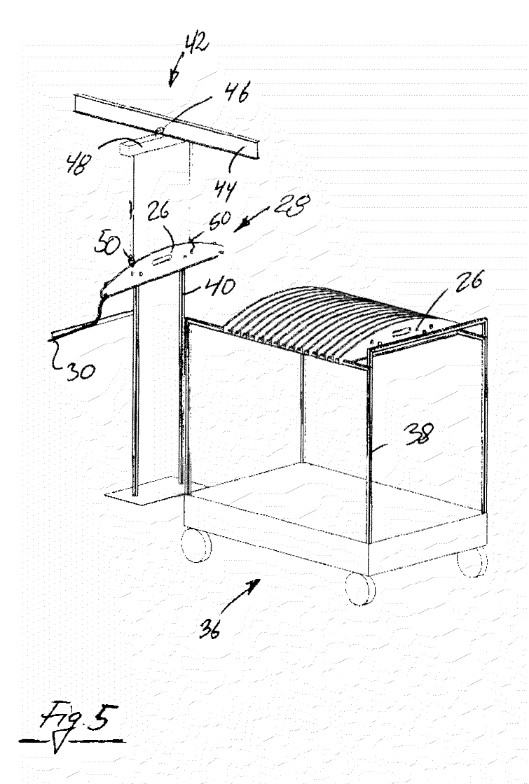

In FIG. 5, the emptying/filling station shown in FIG. 3 can be seen with a magazine-moving arrangement 42 having a jib-arm 44 with a runner 46 which supports a cross-beam 48 with vertically-displaceable gripping devices 50 which can be activated for the moving of magazines 26 between the emptying/filling station 28 and the wheeled transport carriage 36. The displacement and activation/deactivation of the gripping devices 50, and displacement of the runner 46, takes place mechanically and is controlled by a central or local control unit (not shown).

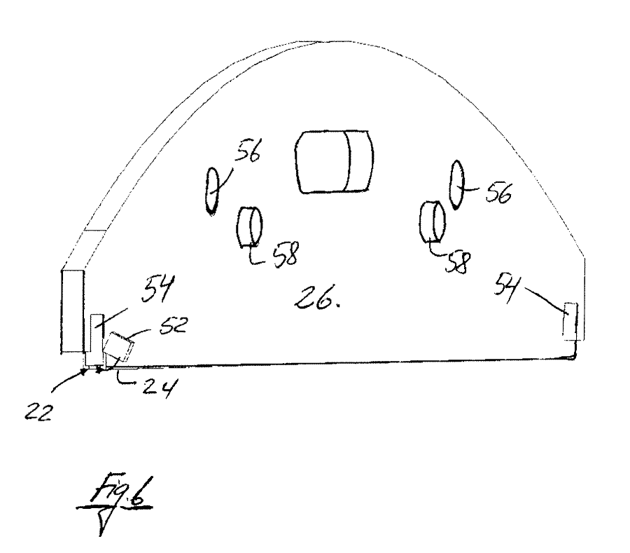

In FIG. 6, which is detailed perspective view of a magazine 26 for transport and handling arrangements 2, as seen at an angle from the front, it is shown that the magazine 26 is provided with a pivotal end-stop 52 which is designed for swinging-in in front of the end 22 of the guide and support rail 24, so that it is ensured that transport and handling arrangements 2 inserted in the magazine are not inadvertently displaced out of the magazine 26. As will also be apparent from FIG. 6, in each end of the magazine, there is a cut-out 54, the geometry of which corresponds substantially to the cross-sectional geometry of the support rails 39 on the rack 38 of the wheeled carriage 36 and which ensure that the magazines do not tip over or fall off during transport. As will also be seen in FIG. 6, the sides of the magazines comprise a number of holes 56 and a number of projections 58. The holes 56 serve for introduction of locking/lifting bars for emptying/handling of a carriage for magazines 26. The projections 58 serve to secure the magazine 26 in the support bracket 40 in the loading station, so that the magazine is not displaced during the loading in of the transport and handling arrangements 2.

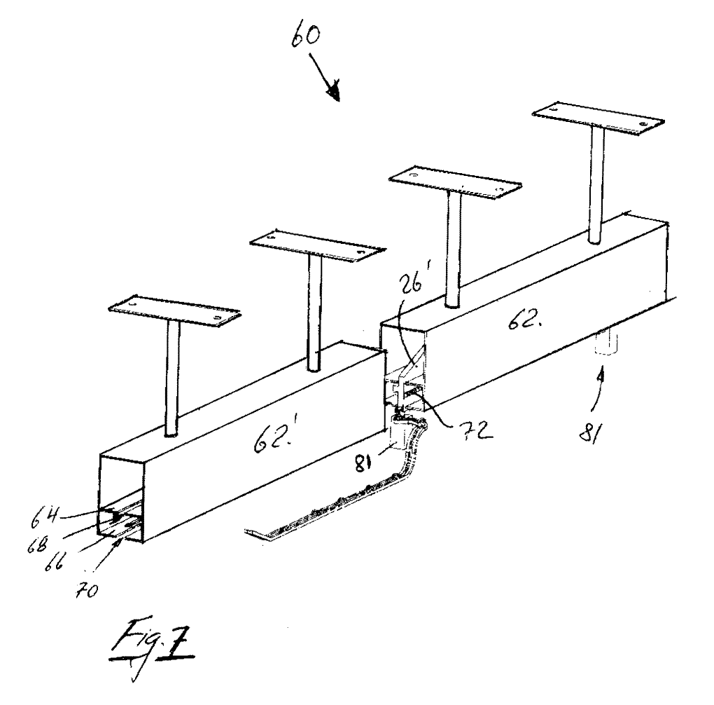

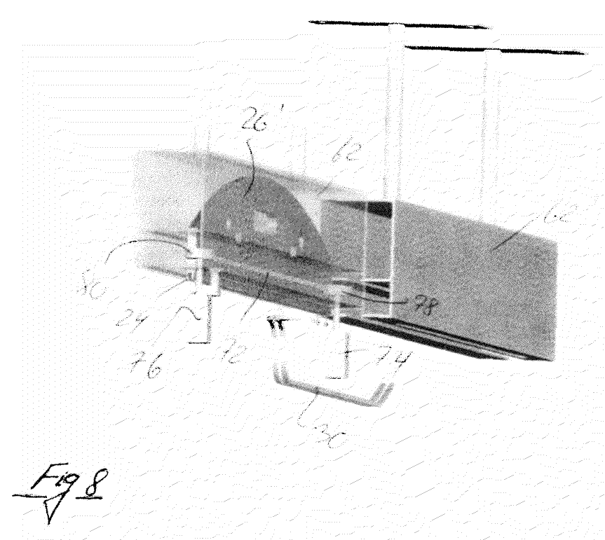

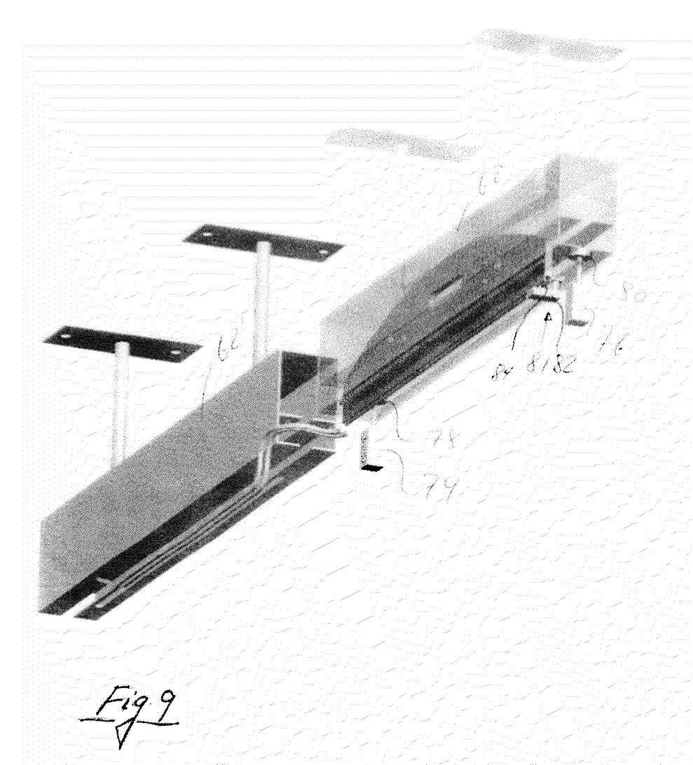

FIGS. 7-9 are perspective views at different angles of a further embodiment of a magazine emptier/filler 60 associated with the individual identification and transport system according to the invention. In this embodiment, the magazine filler/emptier 60 (in the following referred to as the magazine emptier) comprises two spaced box-shaped cabinets 62, 62′ placed in longitudinal extension of each other. The cabinets 62, 62′ comprise a double bottom 64, 66 (cf. FIG. 7) with slots 68, 70 facing towards each other and through which the bottom of the magazine 26′ with guide and support rail 24 extends downwards (cf. FIG. 8). For this embodiment of the individual identification and transport system according to the invention, the magazines 26, the sides of which comprise in-line teeth 72 which cooperate respectively with a first and a second motor-driven feeding unit 74, 76, comprised of pinions 78, 80, which cooperate with the in-line teeth 72 on the sides of the magazines (cf. FIG. 8 and FIG. 9), for securing forwards and backwards feeding of magazines 26′ in the cabinets 62 of the magazine emptier.

The magazine emptier 60 also comprises a motor-driven pusher 81 which comprises an extending part 82 under the cabinet 62, 62′ and which has a bluntly projecting pin 84 extending up through the slot 25 in the guide and support rail 24. By activation of the pusher 80, it will displace the transport and handling arrangements 2 in the guide and support rail 24 in a direction towards the end of the magazine 26′, where the end 31 of a guide rail 30 for receipt of transport and handling arrangements 2 is placed, and with continued displacement of the pusher 80, there will occur an emptying of the magazine 26′ for transport and handling arrangements 2. After emptying of the magazine 26′, it is displaced out of the cabinet 62 by activation of the feeding units 74, 76. In a corresponding manner, the emptying station 60 can be used for the filling of magazines 26′, where the transport and handling arrangements 2 on the guide rail 30 are fed by a pusher (not shown) along the rail, the end of which 31 is disposed in extension of the end 25 of a support and guide rail 24 in a magazine 26′

With the individual identification and transport system according to the invention, there are also associated a number of sorting plants placed de-centrally and centrally, and various relevant scanning units which, via interface, are connected to control and data processing units for the control of said sorting plants, and other units which are used for the handling of pelts from furred animals.

What is claimed is:

1-16. (canceled)

17. Individual identification and transport system for use in the handling of dead furred animals and pelts from furred animals, comprising:
a transport and handling arrangement which is insertable in the nose end of the furred animal, and
an electronically readable data media for individual identification data (ID-data) for a particular furred animal, the electronically readable data media being integrated in the transport and handling arrangement,
wherein said transport and handling arrangement is part of a transport and handling system for transporting and handling of furred animals and pelts from furred animals, and is configured in such a manner that the transport and handling arrangement is able to remain together with the pelt from the furred animal from the time that it is inserted until the pelt is processed into a fur.

18. Individual identification and transport system according to claim 17, wherein the electronically readable data media is also writeable.

19. Individual identification and transport system according to claim 17, wherein the transport and handling arrangement comprises a base element in which the electronically readable and writeable data media is integrated, said base element comprising a protruding flexible band or stalk which has spaced projections, the free end being insertable and locked in openings in at least one locking head of the stalk or band, the band or the stalk being self-locking after insertion of the free end into one of said openings.

20. Individual identification and transport system according to claim 17, wherein the transport and handling system comprises slotted rail profiles with facing surfaces and a slot therebetween, wherein the base element is configured to be receivable in the slotted rail profiles, the base element having at least one slide surface which cooperates with the facing surfaces of the rail profile with the flexible band or stalk extending through the slot in the rail profile.

21. Individual identification and transport system according to claim 17, wherein the free end of the band or stalk is pointed for facilitating insertion through nostrils of a dead fur animal.

22. Individual identification and transport system according to claim 17, further comprising a mounting arrangement for facilitating insertion of the transport and handling arrangement in the nose end of a dead furred animal.

23. Individual identification and transport system according to claim 22, wherein the mounting arrangement comprises a read and write unit connected to a control unit which, via interface, in connection with at least one electronic register in a first data processing unit for at least one of control of and coding of authorized ID-data into the electronically readable and writeable data media, and wherein said mounting arrangement comprises a lock which can be electronically activated for blocking insertion of transport and handling arrangements if the integrated electronically readable and writeable data media does not contain authorized ID-data.

24. Individual identification and transport system according to claim 17, wherein the transport and handling system comprises a plurality of electronic scanning units for reading of ID-data on the electronically readable and writeable data media, said scanning units being connected via an interface to at least one electronic register in at least a second data processing unit containing electronically registered and/or manually registered, reported production data collected at relevant places and times during the course of production of a relevant pelt.

25. Individual identification and transport system according to claim 24, wherein on the basis of the software provided in the second data processing unit for the sorting of pelts, via interface and control software it is arranged in such a manner that it controls one or more sorting plants which are associated with the transport and handling system.

26. Individual identification and transport system according to claim 17, wherein the transport system further comprises a slotted rail system for transport of furred animals and pelts, individually moveable magazines comprising slotted support rails for receiving a number of transport and handling arrangements, wheeled transport carriages comprising support rails for a number of individually moveable magazines, a number of emptying and filling stations for transfer of the transport and handling arrangements to magazines and for transfer of the magazines to and from the emptying and filling stations to and from the wheeled transport carriages, and at least one sorting plant for sorting of pelts into size and color categories.

27. Individual identification and transport system according to claim 26, wherein the magazines comprise an end-stop which is deactivatable.

28. Individual identification and transport system according to claim 26, further comprising a number of scanning units at relevant positions and which, via an interface, are coupled with respective data processing units for locating individual furred animals and pelts.

29. Individual identification and transport system according to claim 18, wherein the electronically readable and writeable data media comprises an RFID chip.

30. Individual identification and transport system according to claim 26, wherein the rail system comprises driving arrangements for the feeding of the transport and handling arrangements.

31. Individual identification and transport system according to claim 28, wherein the interface between reading/writing units for electronic scanning/encoding of ID-data on the electronically readable and writeable data media and respectively the first and the second data processing and control unit, can consist of wireless communication equipment.

32. Individual identification and transport system according to claim 17, wherein the handling and transport arrangement is made of a traction-resistant, flexible material.
